(19) United States
(12) Patent Application Publication
(10) Pub. No.: US 2024/0275837 A1
(43) Pub. Date: Aug. 15, 2024

(54) TRANSMISSION SYSTEM, TRANSMISSION METHOD AND TRANSMISSION PROGRAM

(71) Applicant: Nippon Telegraph and Telephone Corporation, Tokyo (JP)

(72) Inventors: Takuro YAMAGUCHI, Musashino-shi, Tokyo (JP); Yasuhiro MOCHIDA, Musashino-shi, Tokyo (JP); Daisuke SHIRAI, Musashino-shi, Tokyo (JP); Takahiro YAMAGUCHI, Musashino-shi, Tokyo (JP)

(21) Appl. No.: 18/568,350

(22) PCT Filed: Jun. 9, 2021
(86) PCT No.: PCT/JP2021/021912

§ 371 Date: Dec. 8, 2023

(51) Int. Cl. H04L 65/70; H04L 65/611

(52) U.S. Cl. CPC H04L 65/70; H04L 65/611

(57) ABSTRACT

A transmission system including: a duplication unit that duplicates a plurality of packets obtained by packetizing a stream of an uncompressed video; a filter that filters the duplicated packet; and a generation unit that generates a thumbnail image or a low-resolution video from the filtered packet.

### TECHNICAL FIELD

The present invention relates to a transmission system, a transmission method, and a transmission program.

### BACKGROUND ART

SMPTE ST2110 is a system for transmitting uncompressed video and audio through a network. SMPTE ST2110-20 describes a method of storing video essence in a payload of a real-time transport protocol (RTP) packet and transmitting the video essence (Non Patent Literature 1). In the uncompressed video transmission, the number of packets per frame is constant unless a video parameter and a method of pixel mapping to RTP packets are changed.

In the payload portion of the RTP packet, there are a pixel value of a pixel constituting a video and an RTP payload header necessary for reconfiguration on the reception side. In particular, since the coordinates of the head pixel held by the packet are present in the RTP payload header, the pixel value of the pixel is disposed according to the coordinates, so that reconfiguration is performed on the reception side.

### CITATION LIST

### Non Patent Literature

Non Patent Literature 1: SMPTE ST 2110-20:2017, Professional Media Over Managed IP Networks: Uncompressed Active Video

### SUMMARY OF INVENTION

### Technical Problem

It is expected that uncompressed video can be transmitted via a network, and more streams than before are transmitted in the network. Furthermore, in order to use a technique such as redundant transmission, it is necessary to change the construction of the path of the network in real time. When performing such a construction change, it is essential not to adversely affect current stream transmission, and for this purpose, it is necessary to grasp which stream is flowing through which path.

However, in the next generation transmission in which it is assumed that a high-resolution video is transmitted in an uncompressed manner, extremely high processing performance is required in order to acquire all stream information in an operating network as it is and process the stream information in real time, and it can be realized only in a very limited environment.

The present invention has been made in view of the above circumstances, and an object of the present invention is to enable grasping of a stream flowing through a network while reducing a load of the network.

### Solution to Problem

In order to achieve the above object, one aspect of the present invention is a transmission system including: a duplication unit that duplicates a plurality of packets obtained by packetizing a stream of an uncompressed video; a filter that filters the duplicated packet; and a generation unit that generates a thumbnail image or a low-resolution video from the filtered packet.

One aspect of the present invention is a transmission method performed by a transmission system, the transmission method including: a step of duplicating a plurality of packets obtained by packetizing a stream of an uncompressed video; a step of filtering the duplicated packet; and a step of generating a thumbnail image or a low-resolution video from the filtered packet.

One aspect of the present invention is a transmission program for causing a computer to function as the above transmission system.

### Advantageous Effects of Invention

According to the present invention, it is possible to grasp a stream flowing through a network while reducing a load on the network.

### BRIEF DESCRIPTION OF DRAWINGS

FIG. 1 is a diagram illustrating a configuration example of a transmission system of a first embodiment.

FIG. 2 is a flowchart illustrating transmission processing.

FIG. 3 is a diagram illustrating a configuration example of a transmission system of a second embodiment.

FIG. 4 is a diagram illustrating a configuration example of a transmission system of a third embodiment.

FIG. 5 is a diagram illustrating a configuration example of a transmission system of a fourth embodiment.

FIG. 6 is a hardware configuration example.

### DESCRIPTION OF EMBODIMENTS

Hereinafter, embodiments of the present invention will be described with reference to the drawings.

### First Embodiment

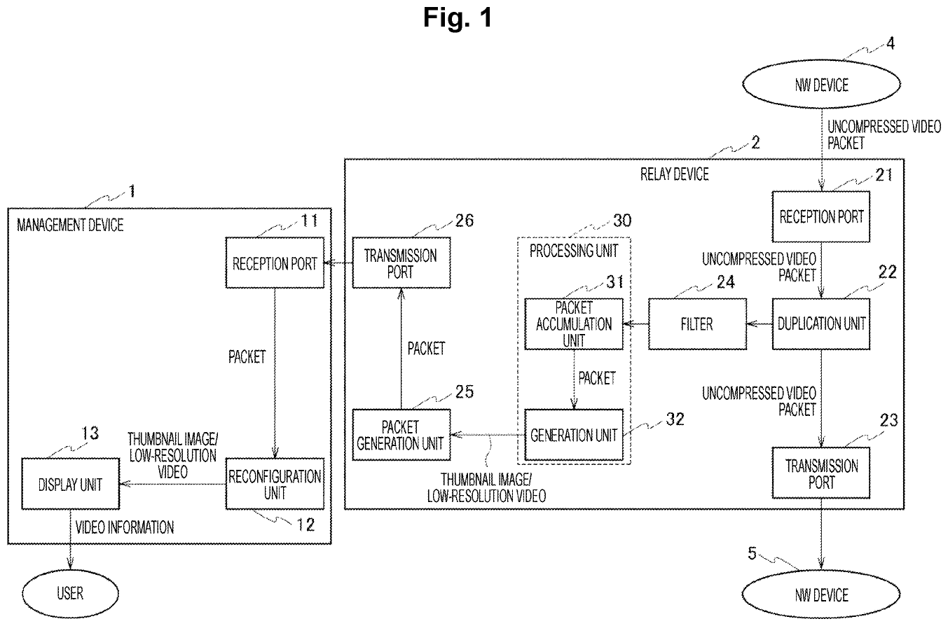

FIG. 1 is a system configuration diagram illustrating a configuration example of a transmission system of the first embodiment.

The transmission system of the present embodiment includes at least one relay device 2 disposed on a network and a management device 1 that aggregates information. The management device 1 and the relay device 2 are connected wirelessly or by wire.

The relay device 2 is connected to other network devices 4 and 5 by wire or wirelessly. The network devices 4 and 5 include, for example, transmission/reception devices and the like. The illustrated relay device 2 relays a stream transmitted from the network device 4 to the network device 5.

The stream of the present embodiment includes pixel value data and coordinate information in uncompressed video like RTP packets packetized according to SMPTE ST 2110. The transmission system of the present embodiment facilitates management and operation such as grasping of the path of each stream in a current network and checking whether a system after change is operating as expected when the path of an uncompressed video stream is changed or a device is added or deleted.

Furthermore, the stream of the present embodiment will be described below with an uncompressed video stream (hereinafter, referred to as a “video stream”) as an example, but may be a stream of uncompressed video and audio.

The illustrated relay device 2 includes a reception port 21, a duplication unit 22, a transmission port 23, a filter 24, a processing unit 30, a packet generation unit 25, and a transmission port 26.

The reception port 21 receives an uncompressed video packet (hereinafter, referred to as a “video packet”) obtained by packetizing the video stream from the network device 4. The duplication unit 22 duplicates (mirrors) the video packet received by the reception port 21 and sends the packet to the filter 24. Furthermore, the duplication unit 22 outputs the received video packet to the transmission port 23. The transmission port 23 transmits the video packet to the next network device 5.

Note that although the RTP packet is used as the video packet in the present embodiment, the video packet is not limited to the RTP packet, and a packet other than the RTP packet may be used.

In the present embodiment, before the video packet is transmitted to the management device 1, the filter 24 filters the video packet in the relay device 2. The filter 24 filters (passes or discards) the duplicated video packet according to a predetermined criterion.

In filtering, the number of packets to be held and the disposition thereof are important. It is necessary to suppress the number of packets to a minimum necessary number so that processing can be performed even in a narrow band. Furthermore, even when the number of packets is the same, the number of packets per unit time can be reduced by acquiring packets over a plurality of frames as compared with a case where packets are intensively acquired for one frame. When packets are acquired over a plurality of frames, the amount of information for each local area may be increased by acquiring packets at different positions in different frames.

The filter 24 sends the filtered video packet to a packet accumulation unit 31 of the processing unit 30.

The processing unit 30 includes the packet accumulation unit 31 and a generation unit 32. The filtered video packet is accumulated in the packet accumulation unit 31. When the packet amount necessary for generating a thumbnail image or a low-resolution video is accumulated, the packet accumulation unit 31 sends the video packets to the generation unit 32.

Regarding the setting of the necessary number of packets, there may be a restriction that the end of the packet at the end of the frame is left by filtering, and the frame unit may be grasped by a marker of the RTP header. Furthermore, the number of packets constituting one frame may be known, and the number of packets after decimation used for image processing may be set without considering the head or end of the frame, and may be acquired over a plurality of consecutive frames until the setting number is reached.

The generation unit 32 generates a thumbnail image or a low-resolution video (low-resolution frame) from the filtered video packet, and sends the thumbnail image or the low-resolution video to the packet generation unit 25. The generation unit 32 acquires the pixel value data of the uncompressed video and the coordinates (position information) of the pixel value data from the video packet, and generates the thumbnail image or the low-resolution video using the pixel value data and the coordinates.

Specifically, the generation unit 32 acquires the coordinates of the pixel value data held in a media payload from the payload header of the RTP packet (video packet) defined in SMPTE 2110. The RTP packet includes an RTP header, a payload header including information (such as coordinates) related to pixel value data, and a media payload including pixel value data.

As a method of creating a thumbnail image or a low-resolution video, the generation unit 32 may perform image reduction using a classical resampling method (resolution conversion method) such as Bilinear or Bicubic on the acquired coordinates.

In a case where the processing is performed from the pixel value data over a plurality of frames, the generation unit 32 may adopt a method of processing a certain frame as main information, selecting a frame for each local area, reducing the influence of a small movement amount by increasing the reduction ratio, or the like, instead of uniformly handling frames to be handled in consideration of object movement between the frames.

As another reduction method, the generation unit 32 may utilize machine learning (learning model). In this case, the generation unit 32 may generate a thumbnail image or a low-resolution video by using a learning model obtained by machine learning using the pixel value data and the coordinates of the RTP packet or an output image obtained by the above-described resampling method as an input.

Furthermore, the generation unit 32 may solve a regression problem of reconfiguring an incomplete image in which only known pixels of the acquired pixel value data are disposed on the basis of coordinates and generating a thumbnail image from the incomplete image.

Furthermore, the generation unit 32 may be notified in advance of important part coordinates or the like representing the outline of the video as sub information, and the generation unit 32 may reduce the image size by adopting trimming or seam carving including the important part coordinates or the like.

Furthermore, the generation unit 32 may switch the generation method on the basis of the required resolution in a display unit 13, the amount of streams to be processed in parallel, and the like, instead of a single method. For example, when displaying a plurality of streams side by side, the generation unit 32 may use a resampling method and utilize machine learning in a case where a request for checking the outline of one of the pieces is input.

The packet generation unit 25 packetizes the thumbnail image or the low-resolution video generated by the generation unit 32 to generate a plurality of video packets, and sends the generated video packets to the transmission port 26. The transmission port 26 transmits the received video packets to the management device 1.

A video packet of a thumbnail image or a low-resolution video transmitted from one or a plurality of relay devices 2 is input to the management device 1. Furthermore, when relaying a plurality of video streams, the relay device 2 transmits a video packet of a thumbnail image or a low-resolution video to the management device 1 for each video stream.

The management device 1 includes a reception port 11, a reconfiguration unit 12, and the display unit 13. Note that the management device 1 may not include the display unit 13, and may include a display device (display) outside the management device 1.

The reception port 11 receives a video packet from the relay device 2 and sends the video packet to the reconfiguration unit 12. The reconfiguration unit 12 reconfigures the video packet to reconfigure the thumbnail image or the low-resolution video, and outputs the thumbnail image or the low-resolution video to the display unit 13. The display unit 13 displays a thumbnail image or a low-resolution video.

As a result, the thumbnail image or the low-resolution video generated by the generation unit 32 of the relay device 2 is finally displayed on the display unit 13 of the management device 1 or on the display device installed outside via a network. Therefore, the video stream on the network is visualized and displayed in a form visible to the user.

The display unit 13 may display information indicating what video stream is flowing between which devices on the network by using a thumbnail image or a low-resolution video. That is, the display unit 13 may display a thumbnail image or a low-resolution video as a video stream flowing between the network devices 4 and 5. For example, the display unit 13 may display a line indicating connection between devices and a thumbnail image or a low-resolution video superimposed on the line.

In the display unit 13, for example, a simple indication such as a block diagram by a GUI is assumed. The line indicating the connection between the devices may be displayed by acquiring the path in advance by confirming that the management device 1 or the relay device 2 can actually communicate by ping or the like. Furthermore, the line indicating the connection between the devices may be displayed by the management device 1 acquiring the path by acquiring information from an NMOS (which manages information of a terminal present on the network) to be described below when actually performing transmission. Furthermore, the reconfiguration unit 12 may acquire a transmission source address and a destination address included in the video packet, and acquire the line indicating the connection between the devices.

Furthermore, when a user visually recognizes a fiber (transmission path) through which a video stream flows on the display device outside the management device 1, for example, a head mounted display, a thumbnail image or the like may be displayed to be superimposed on the fiber. Specifically, when the user visually recognizes or gazes at a fiber in the real world actually connected through a display such as AR glasses, a thumbnail image or the like of a video stream flowing through the fiber is displayed to be superimposed on the fiber.

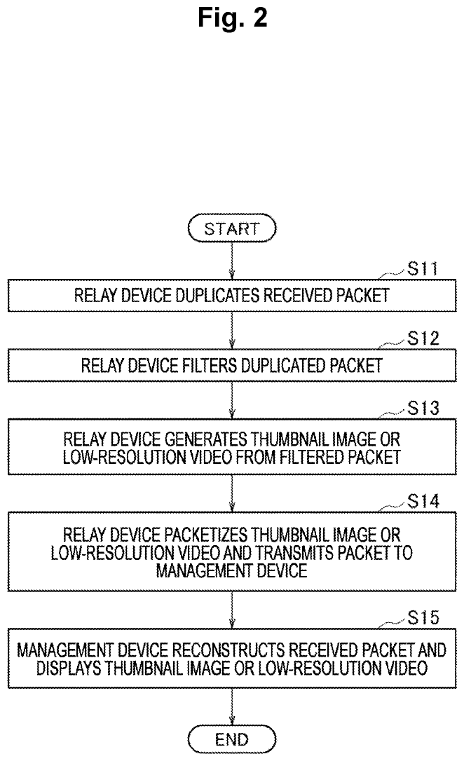

FIG. 2 is a flowchart illustrating transmission processing of the present embodiment.

The relay device 2 receives a video packet (RTP packet) obtained by packetizing an uncompressed video stream from the network device 4, and duplicates the received video packet (S11). Furthermore, the relay device 2 transmits the received video packet to the network device 5.

The relay device 2 filters to decimate the duplicated video packet (S12), and generates a thumbnail image or a low-resolution video by using the packet after decimation (S13). The relay device 2 packetizes the generated thumbnail image or low-resolution video, and transmits a plurality of video packets to the management device 1 (S14).

The management device 1 receives the video packet from relay device 2, reconfigures the received video packet, and displays the thumbnail image or the low-resolution video (S15).

### Second Embodiment

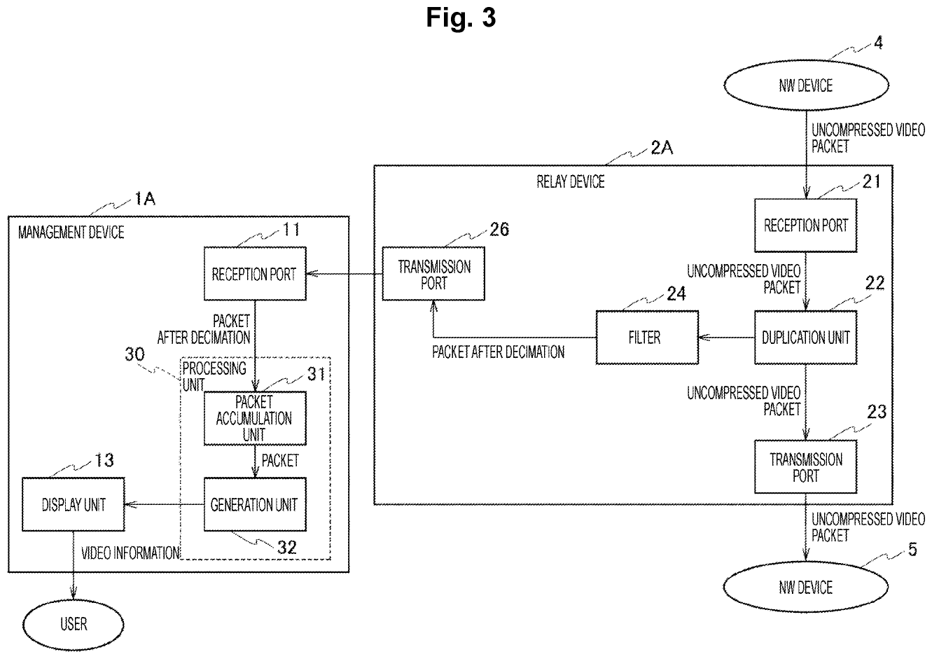

FIG. 3 is a system configuration diagram illustrating a configuration example of a transmission system of the second embodiment. The transmission system of the present embodiment includes at least one relay device 2A and a management device 1A.

In the present embodiment, the processing unit 30 is provided not in the relay device 2A but in the management device 1A. The rest is the same as in the first embodiment.

Specifically, the relay device 2A includes the reception port 21, the duplication unit 22, the transmission port 23, the filter 24, and the transmission port 26. The management device 1A includes the reception port 11, the processing unit 30, and the display unit 13.

In the present embodiment, the filter 24 of the relay device 2A filters the duplicated video packet and sends the filtered packet to the transmission port 26.

The reception port 11 of the management device 1A receives the filtered video packet and sends the video packet to the processing unit 30. The processing unit 30 generates a thumbnail image or a low-resolution video from the filtered video packet as in the first embodiment. The display unit 13 displays the generated thumbnail image or low-resolution video.

### Third Embodiment

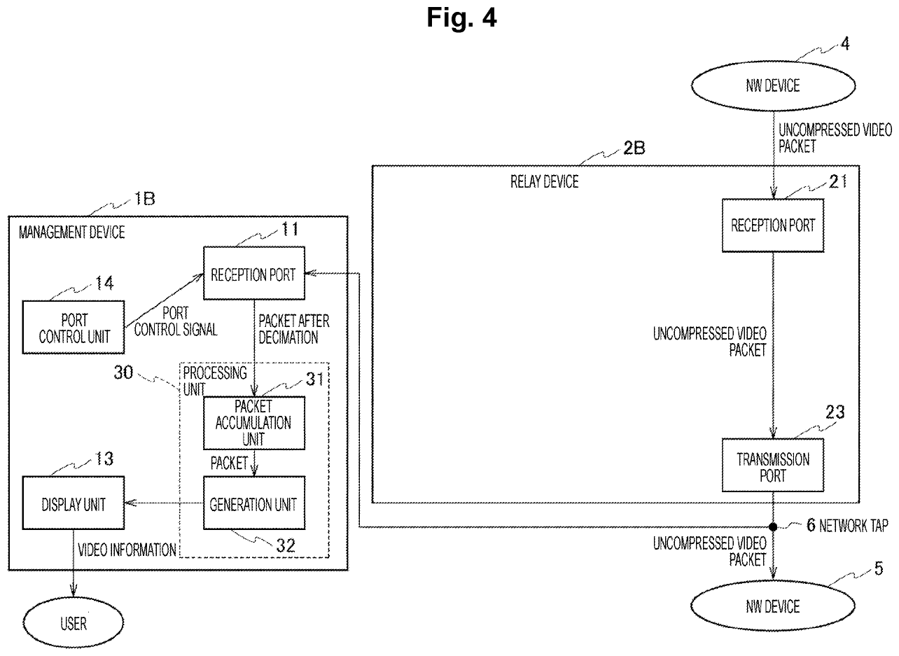

FIG. 4 is a system configuration diagram illustrating a configuration example of a transmission system of the third embodiment. The transmission system of the present embodiment includes at least one network tap 6 and a management device 1B.

In the present embodiment, the network tap 6 is connected to a fiber (transmission path) between the two network devices 4 and 5, and the network tap 6 physically duplicates a video stream.

The network tap 6 is a device that branches and extracts a video packet flowing on the network. The network tap 6 physically duplicates a video packet obtained by packetizing an uncompressed video stream to generate a mirror packet, and transmits the mirror packet to the management device 1B, which is a branch destination.

The illustrated network tap 6 is installed on a fiber between a relay device 2B and the network device 5. The network tap 6 physically duplicates the video packet output from the relay device 2B and transmits the duplicated video packet to the management device 1B.

The management device 1B of the present embodiment includes the reception port 11, the processing unit 30, the display unit 13, and a port control unit 14. The management device 1B, which includes the port control unit 14, is different from that of the second embodiment illustrated in FIG. 2.

In the present embodiment, since the video packet received by the management device 1B is an unfiltered packet, the reception port 11 of the management device 1B selectively acquires the video packet under the control of the port control unit 14 to perform the filtering processing.

The port control unit 14 sends a control signal to the reception port 11 by a predetermined filtering method, and causes the reception port 11 to discard or receive the video packet to perform filtering. When the management device 1B includes a plurality of reception ports 11, the port control unit 14 may perform time-division filtering by transmitting a control signal to each reception port 11 and sequentially switching the reception ports 11 that receive the video packet.

Alternatively, the port control unit 14 may cause each reception port 11 to select the video packet to be discarded and the video packet to be received by using header information (sequence number, arrival order of arrival packets, or the like) set in the RTP header of the received video packet. That is, the port control unit 14 may perform filtering by a packet division method of selecting a video packet by using information that can be acquired from the video packet. In this case, the port control unit 14 sends a control signal specifying the header information of the video packet received by each reception port 11, and each reception port 11 receives only the video packet specified by the control signal and discards the other video packets.

The reception port 11 outputs the filtered packet to the processing unit 30. The processing unit 30 generates a thumbnail image or a low-resolution video from the filtered video packet as in the first embodiment. The display unit 13 displays the generated thumbnail image or low-resolution video.

Note that the relay device 2B of the present embodiment includes the reception port 21 and the transmission port 23, and relays a video packet of an uncompressed video stream received from the network device 4 to the network device 5.

### Fourth Embodiment

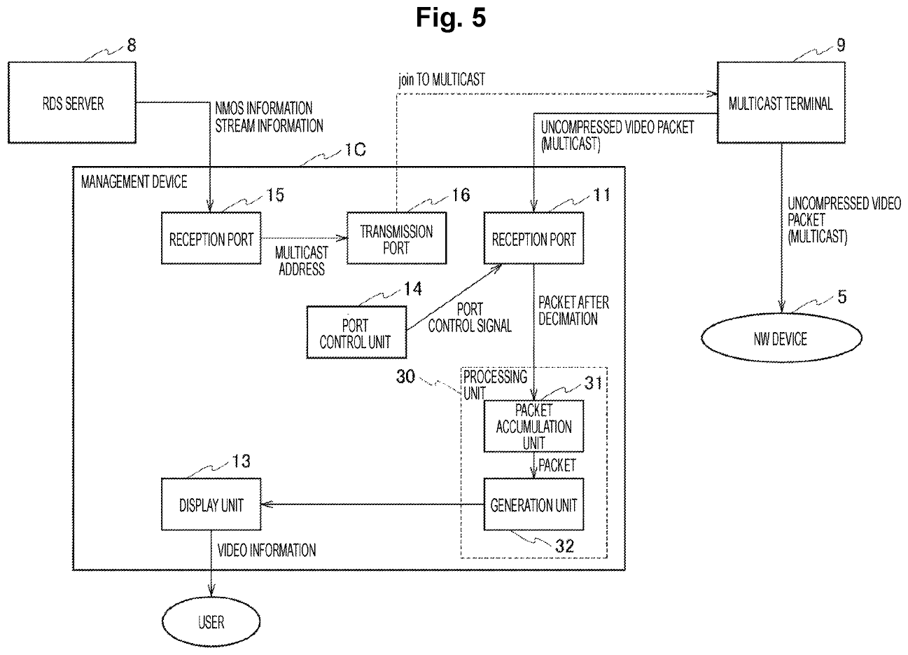

FIG. 5 is a system configuration diagram illustrating a configuration example of a transmission system of the fourth embodiment.

The transmission system of the present embodiment includes a management device 1C. The management device 1C acquires network device information and stream information from a registration & discovery system (RDS) server 8 of networked media open specifications (NMOS), and acquires a multicast address of a desired multicast terminal 9 from the device information. Then, the management device 1C transmits a join to the multicast terminal 9 using the multicast address and participates in multicast. As a result, the management device 1C can acquire the same video stream as the video stream (video packet) flowing from the multicast terminal 9 to the network device 5.

The illustrated management device 1C includes the reception port 11, the processing unit 30, the display unit 13, the port control unit 14, an other reception port 15, and a transmission port 16. The management device 1C, which includes the other reception port 15 and the transmission port 16, is different from the management device 1B of the third embodiment illustrated in FIG. 4.

The other reception port 15 acquires network device information (NMOS information) and stream information from the RDS server 8. The RDS server 8 is a server that detects and registers devices in a network. The other reception port 15 acquires the multicast address of the multicast terminal 9 that distributes a desired stream from these pieces of information, and sends the multicast address to the transmission port 16.

The transmission port 16 transmits a join to the multicast terminal 9 using the multicast address. As a result, the multicast terminal 9 transmits the same video stream as the video stream (video packet) transmitted to the network device 5 or the like to the management device 1C.

The reception port 11 of the management device 1C receives the video packet transmitted by the multicast terminal 9. As in the third embodiment, the reception port 11 filters the packet under the control of the port control unit 14 and outputs the filtered packet to the processing unit 30. The processing unit 30 generates a thumbnail image or a low-resolution video from the filtered video packet as in the first embodiment. The display unit 13 displays the generated thumbnail image or low-resolution video.

### Effects of the Embodiments

The transmission system of the first to fourth embodiments described above includes the duplication unit 22 that duplicates a plurality of packets obtained by packetizing the stream of the uncompressed video, the filter 24 that filters the duplicated packet, and the generation unit 32 that generates a thumbnail image or a low-resolution video from the filtered packet. The duplication unit may duplicate the video packet by using at least one of mirroring in the transmission system, physical duplication using the network tap 6, and multicast participation.

As a result, in the present embodiment, it is possible to grasp a stream flowing through a network while reducing a load on the network. Specifically, by reducing a video packet by filtering, generating a thumbnail image or a low-resolution video from the reduced video packet, and transmitting the thumbnail image or the low-resolution video to the management device 1 (maintenance base), it is possible to visualize the video stream in real time while reducing the load of the network. That is, the video stream flowing through the network can be visualized even in a narrow transmission band.

Furthermore, the processing cost can be reduced by reducing the number of video packets by filtering and generating a thumbnail image or the like from limited information, and a plurality of video streams can be visualized in parallel in real time even in a narrow transmission band.

### <Hardware Configuration>

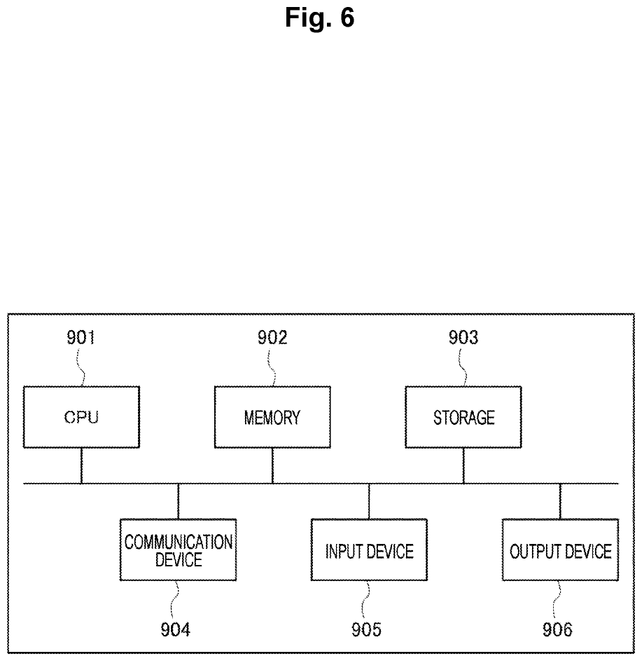

As the management devices 1, 1A, 1B, and 1C and the relay devices 2 and 2A described above, for example, a general-purpose computer system as illustrated in FIG. 6 can be used. The illustrated computer system includes a central processing unit (CPU, processor) 901, a memory 902, a storage 903 (hard disk drive (HDD), solid state drive (SSD)), a communication device 904, an input device 905, and an output device 906. The memory 902 and the storage 903 are storage devices. In the computer system, by the CPU 901 executing a predetermined program loaded on the memory 902, each function of each device is implemented. For example, each function of the management devices 1, 1A, 1B, and 1C and the relay devices 2 and 2A is implemented by the CPU of the management device executing a program in a case of a program for the management device and by the CPU of the relay device executing a program in a case of a program for the relay device.

Furthermore, the management device and the relay device may be implemented by one computer, or may be implemented by a plurality of computers. Furthermore, the management device and the relay device may be a virtual machine mounted on a computer. The program for the management device and the program for the relay device can be stored in a computer-readable recording medium such as an HDD, an SSD, a universal serial bus (USB) memory, a compact disc (CD), or a digital versatile disc (DVD) or can be distributed via a network.

Note that the present invention is not limited to the above embodiments, and various modifications can be made within the scope of the gist of the present invention.

### REFERENCE SIGNS LIST

1, 1A, 1B, 1C Management device
11, 15 Reception port
12 Reconfiguration unit
13 Display unit
14 Port control unit
16 Transmission port
2, 2A, 2B Relay device
21 Reception port
22 Duplication unit
23, 26 Transmission port
24 Filter
25 Packet generation unit
30 Processing unit
31 Packet accumulation unit
32 Generation unit
4, 5 Network device
6 Network tap
8 RDS server
9 Multicast terminal

1. A transmission system comprising:
a duplication unit, comprising one or more processors, configured to duplicate a plurality of packets obtained by packetizing a stream of an uncompressed video;
a filter configured to filter the duplicated packet; and
a generation unit comprising one or more processors, configured to generate a thumbnail image or a low-resolution video from the filtered packet.

2. The transmission system according to claim 1, wherein the generation unit is configured to acquire pixel value data of the uncompressed video and position information of the pixel value data from the packet, and generate the thumbnail image or the low-resolution video.

3. The transmission system according to claim 1, wherein the duplication unit is configured to duplicate the packet by using at least one of mirroring in the transmission system, physical duplication using a network tap, and multicast participation.

4. The transmission system according to claim 1, wherein the generation unit is configured to generate the thumbnail image or the low-resolution video by using at least one of resampling, machine learning, trimming, and seam carving.

5. The transmission system according to claim 1, comprising:
a display unit configured to display the thumbnail image or the low-resolution video as the stream flowing between network devices.

6. A transmission method performed by a transmission system, the transmission method comprising:
duplicating a plurality of packets obtained by packetizing a stream of an uncompressed video;
filtering the duplicated packet; and
generating a thumbnail image or a low-resolution video from the filtered packet.

7. A non-transitory computer readable medium storing a program, wherein execution of the program causes a computer to function as a transmission system according to claim 1.
